(19) United States
(12) Patent Application Publication
(10) Pub. No.: US 2015/0008090 A1
(43) Pub. Date: Jan. 8, 2015

(54) FRICTION DEVICE FOR A CLUTCH

(71) Applicant: VALEO MATERIAUX DE FRICTION, Limoges Cedex 9 (FR)

(72) Inventors: Loïc Adamczak, Roussac (FR); Gérard Crosland, La Souterraine (FR); Franck Delavente, Verneuil Sur Vienne (FR); Pascal Denis, Rilhac-lancon (FR)

(21) Appl. No.: 14/367,161

(22) PCT Filed: Dec. 14, 2012
(86) PCT No.: PCT/FR2012/052947

§ 371 Date: Jun. 19, 2014

(30) Foreign Application Priority Data
Dec. 22, 2011 (FR) 1162341

(51) Int. Cl. F16D 13/64; B32B 37/18

(52) U.S. Cl. CPC F16D 13/64; B32B 37/182
USPC 192/107 R; 156/307.1

(57) ABSTRACT

A friction device (1) for a clutch, comprising at least two opposite annular friction linings (2, 2′) each having at least one friction body attached to a support (4, 4′) and elastic means (3) arranged between the opposite supports (4, 4′) so as to allow the supports to move axially together or apart by compression or relaxation of the elastic means (3). The friction device (1) furthermore has means for limiting the axial spacing between the supports, formed by at least one stop member (15) extending axially from one support (4) to the other (4′) and disposed on the radially outer (14) or inner periphery of the supports (4, 4′).

The present invention relates to a friction device for a clutch, intended to be part of a motor vehicle.

A motor vehicle clutch is intended to transmit a torque between a driving shaft, for example a crankshaft of an engine, and an input shaft of a gearbox. For this, the clutch has a mechanism coupled to the driving shaft and a friction disk coupled to the input shaft of the gearbox.

The clutch mechanism has a pressure plate and a reaction plate movable axially with respect to one another so as to clamp or release the friction disk respectively in the engagement phase and disengagement phase.

The friction disk has two opposite friction linings connected to an annular flange or to a hub of the friction disk. Each lining has an annular friction body attached to an annular support. The supports are generally metallic shims between 0.2 and 1 mm thick. The friction bodies are made conventionally of a fibrous material, a binder, and fillers, as known in particular from the document FR 2 941 758 in the name of the Applicant.

In the engagement phase the pressure plate and reaction plate are intended to become braced against the friction bodies of the linings.

The friction disk must conform to a variety of technical constraints.

On the one hand, the mass and inertia of the friction disk should be limited. For this, the axial and radial dimensions of the friction linings should be limited. It can also be preferably to avoid attaching the friction bodies to the supports using rivets, given the mass of the latter. It is therefore preferable to accomplish this attachment by adhesive bonding or by hot pressing, when possible.

On the other hand, it is useful to be able to engage and disengage progressively, i.e. to progressively increase or reduce the torque transmitted from the driving shaft to the gearbox shaft by way of the friction disk.

Patent FR 2 871 538 in the name of the Applicant therefore proposes to insert elastic means between the two opposite friction linings, more specifically between the two supports of said linings. These elastic means can comprise either elastic tongues extending circumferentially and shaped into at least one of the supports, or concentric annular elements made of elastomer.

When the progressiveness function is performed using elastic tongues, at least some of the tongues can also serve to limit the spacing between the supports. These tongues extend circumferentially, and are located in a middle annular zone of the friction linings.

The structure of these linings is relatively complex, as is the installation and production thereof.

The object of the invention is in particular to provide a simple, effective, and economical solution to this problem.

It proposes for this purpose a friction device for a clutch, comprising at least two opposite annular friction linings each having at least one friction body attached to a support, and elastic means arranged between the opposite supports so as to allow the supports to move axially together or apart by compression or relaxation of the elastic means, the friction device further having means for limiting the axial spacing between the supports, wherein the means for limiting the axial spacing between the supports have at least one stop member extending axially from one support to the other and disposed at the radially outer or inner periphery of the supports.

The progressiveness function of the clutch, provided by the elastic means, is thus dissociated from the function of limiting the axial spacing between the supports. It is thus possible, for example, to dimension the elastic elements as a function of certain requirements without substantially modifying the dimensioning or geometry of the stop member, and vice versa. This also allows the use of elastic means having a relatively simple structure, for example elastic means made of elastomer, while retaining the spacing limitation function.

In the existing art, conversely, the same elastic tongues provide simultaneously the progressiveness or elasticity function and that of limiting the axial spacing between the supports. These tongues have a level of alternating stress that can decrease the reliability of the system.

The fact that the stop member is positioned at the outer or inner periphery facilitates access thereto, and thus installation or removal of the friction device.

According to a characteristic of the invention, the stop member is formed by a tab that is integral with one of the supports and is bent over axially toward the other support, the free end of the tab having at least one hook or rim extending radially inward and able to come into abutment against the radially outer or inner periphery of the other support.

The stop member is thus formed as a single part with the support, which allows the mass and inertia of the friction device to be reduced.

As a variant, the stop member is formed by a member different from the supports and is generally in the shape of a U having two radial limbs connected by an axial base, one of the limbs being attached to the radially outer or inner periphery of one of the supports, the other limb being able to come into abutment against the radially outer or inner periphery of the other support.

Advantageously, the radially outer or inner periphery of the other support has an area recessed toward the opposite support, intended to accommodate the hook or rim of the tab or intended to accommodate the corresponding limb of the stop member.

That surface of the support which exhibits the recessed area intended for attachment of the friction body thus does not exhibit any projecting element that can interfere with the friction body.

In addition, the respective radially outer and radially inner peripheries of the supports can have areas indented respectively inward and outward, at which the stop members are disposed.

The stop members thus do not project radially toward the outside or inside of the supports, so as not to interfere with other elements.

The stop member can moreover have a radially extending grip tab in order to facilitate installation and/or removal of the friction device.

As a variant, at least one of the supports has at least one first tab intended to be engaged into an opening configured in the opposite support, the first tab being designed to come into abutment against an edge of the opening in order to limit the axial displacement of one support with respect to the other.

The opening is preferably configured in a second tab extending from the other support.

The first tab and/or the second tab can extend toward the opposite support.

The elastic means preferably have at least one deformable element made of elastomer, for example concentric annular elements made of elastomer.

The friction device can furthermore have at least one stop limiting how axially close the supports can come, as is known from the patent application FR 11/61042 filed by the Applicant and not yet published. These stops allow the compression of the elastic means in the engagement phase to be limited, in order to avoid degradation thereof.

Specifically, in the event of an axial engagement overload combined with significant thermal stress, the elastic means providing the progressiveness function are subject to overpressure. Degradation of the elastic means causes the coupling progressiveness to deteriorate, and can even result in faulty torque transmission if the elastic means no longer exhibit sufficient elasticity.

Axial engagement overloads of this kind can be caused in particular by wear on the friction linings in a normally-closed type of clutch, the effect of wear on the linings being to increase the load on the diaphragm. These engagement overloads can also arise from malfunctions in the guidance process in the case of a normally-open type of clutch.

The stops axially limit deformation of the elastic means, which are then protected in the event of overload.

According to another characteristic of the invention, the elastic means are designed, as they relax, to cause the supports to move apart to a value corresponding to a first spacing, the stop member preventing the supports from moving apart beyond a second spacing greater than or equal to the first spacing.

In other words, the stop member is active only after complete relaxation of the elastic means. The spacing-limitation function thus does not interfere with the progressiveness function or elasticity function.

The invention likewise relates to a method for producing a friction device of the kind recited above, wherein it comprises the steps of:
placing annular cords made of elastomer onto one surface of one of the supports;
placing the other support onto the cords made of elastomer, the two opposite supports being kept parallel at a defined axial distance from one another,
at least partly polymerizing the cords made of elastomer,
positioning or engaging the stop member on the radially outer or inner periphery of the supports before or after the placement and polymerization of said cords.

The invention will be better understood, and other details, characteristics, and advantages of the invention will emerge, upon reading the description below supplied as a non-limiting example referring to the attached drawings, in which:

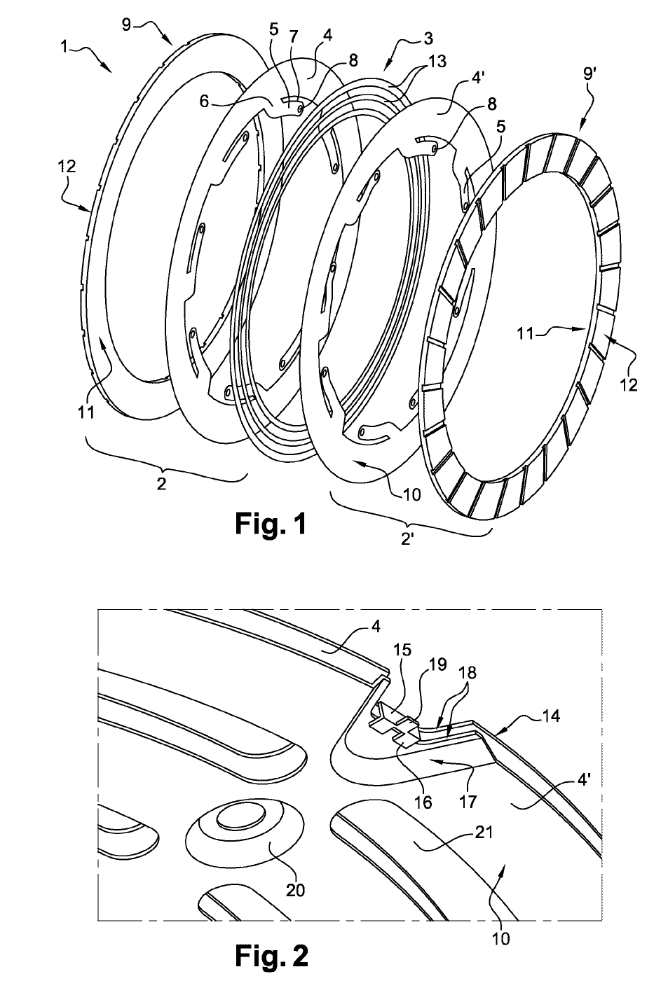

FIG. 1 is an exploded perspective view of a friction device of the existing art,

FIG. 2 is a perspective detail view of two opposite supports and of a stop member of a friction device according to the invention,

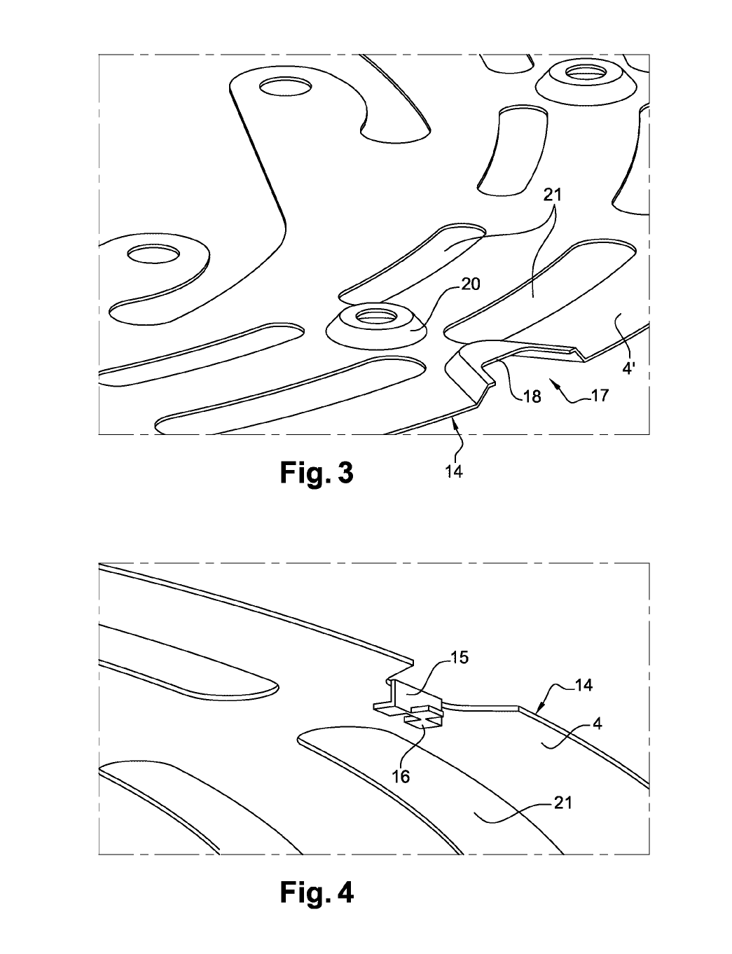

FIGS. 3 and 4 are perspective detail views of each of the supports of the friction device according to the invention,

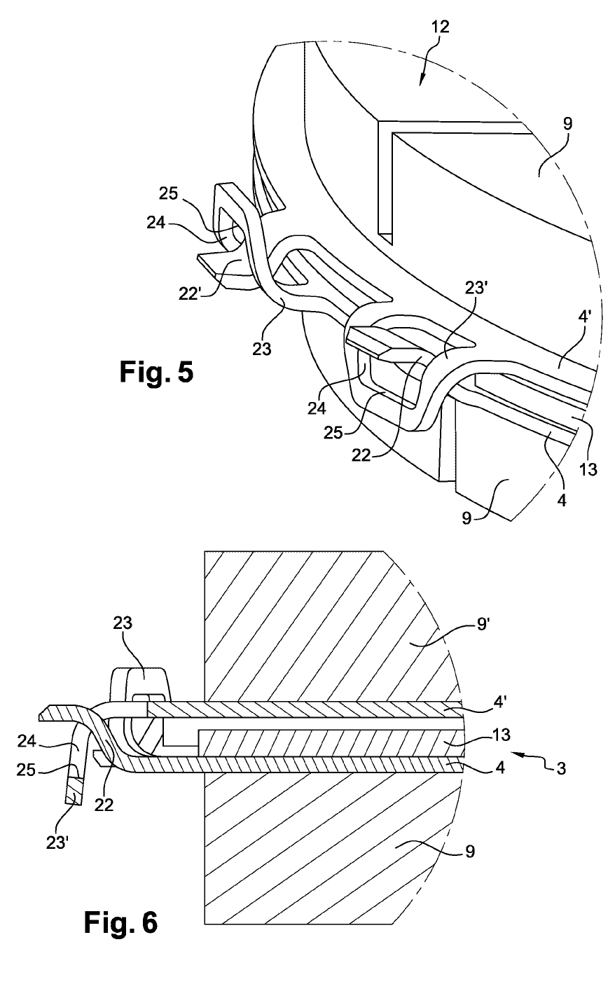

FIG. 5 is a perspective detail view illustrating another embodiment of the invention,

FIG. 6 is an axially sectioned detail view illustrating the embodiment of FIG. 5.

FIG. 1 depicts a friction device 1 of the existing art, having two opposite and coaxial annular friction linings 2, 2′ between which elastic means 3 are disposed.

Each friction lining 2, 2′ has a support formed by an annular shim 4, 4′, i.e. a thin foil of metallic material having a thickness generally between 0.2 and 1 mm. Shims 4, 4′ have tongues 5 extending from the inner radial periphery, said tongues 5 having a first end 6 connected to the radially inner periphery and a second end 7 having a hole 8 for passage of a rivet for attachment to a hub or to a flange of a friction disk (not depicted). The hub, or more generally the friction disk, are intended to be coupled to an input shaft of a gearbox, as is known per se.

Ends 6 and 7 are axially offset from one another. More particularly, second end 7 is spaced axially away from first end 6 toward the opposite shim. Tongues 5 are elastically and axially deformable in order to allow one shim to move toward or away from the other.

Annular friction bodies 9, 9′ are mounted on those surfaces 10 of shims 4, 4′ which are opposite to elastic means 3. These friction bodies 9, 9′ are made conventionally of a fibrous material, a binder, and fillers, as known in particular from the document FR 2 941 758 in the name of the Applicant.

Friction bodies 9, 9′ have a thickness of between 2.5 and 5 mm, for example.

Each friction body 9, 9′ has a radial attachment surface 11 turned toward the corresponding shim 4, 4′ and a radial friction surface 12 opposite to attachment surface 11.

Attachment surfaces 11 are, for example, glued onto the corresponding shims 4, 4′.

Friction surfaces 12 are intended to interact with a pressure plate and a reaction plate of a clutch mechanism (not depicted) in order to transmit a torque from a driving member, such as a crankshaft of a combustion engine, to the input shaft of the gearbox.

Elastic means 3 are formed by concentric annular cords 13 made of elastomer, for example made of silicone.

In operation, during an engagement phase friction device 1 is clamped between the pressure plate and reaction plate so that linings 2, 2′ come close to one another due to deformation of tongues 5 and of cords 13 made of elastomer. Compression of cords 13 made of elastomer allows an axial deflection between the two linings 2, 2′ that is between 1 and 4 mm, and preferably from 1.5 to 2.5 mm.

This allows torque to be transferred progressively from the driving shaft, rotationally coupled to the pressure plate and reaction plate, to the input shaft of the gearbox.

A friction device 1 of this kind is described in more detail in patent FR 2 871 538 in the name of the Applicant.

The invention proposes to combine this friction device 1 with means for limiting the axial spacing between shims 4, 4′.

For this, as depicted in FIGS. 2 and 4, friction device 1 has at least one stop member extending axially from one shim 4 to the other 4′ and disposed at radially outer periphery 14 of shims 4, 4′, preferably at least two diametrically opposite stop members.

In a variant that is not depicted, the stop member or members can be positioned at the radially inner periphery of shims 4, 4′.

In the embodiment depicted in FIGS. 2 and 4, the stop member is formed by a tab 15 integral with shim 4 and bent over axially toward shim 4′, the free end of tab 15 having at least one hook or rim 16 extending radially inward and able to come into abutment against radially outer periphery 14 of the other shim 4′.

In a variant that is not depicted, the stop member is formed by a member different from shims 4, 4′ and is generally in the shape of a U having two radial limbs connected by an axial base, one of the limbs being attached to radially outer periphery 14 of one of shims 4, 4′, for example by laser welding, the other limb being able to come into abutment against radially outer periphery 14 of the other shim.

Radially outer periphery 14 of shim 4′ comprises an area 17 recessed toward shim 4, intended to accommodate the hook or rim of the tab (FIGS. 2 and 3).

Outer peripheral edges 14 of the shims also have areas 18 indented radially inward, such that the tab extends from indented area 18 of shim 4, and hook or rim 16 of the tab comes into interaction with indented area 18 of shim 4′.

Tab 15 thus does not protrude outward either axially or radially, and presents no risk of interfering with other elements.

A grip tab 19 furthermore extends radially outward from hook or rim 16.

Elastic means 3 are designed, as they relax, to cause shims 4, 4′ to move apart to a value corresponding to a first spacing, tab 15 preventing shims 4, 4′ from moving apart beyond a second spacing greater than or equal to the first spacing. As an example, the first spacing (caused by the relaxation of elastic means 13) is on the order of 0.6 mm and the second spacing (allowed by tab 15) is between 0.65 and 0.7 mm. Stop member 15 is thus active only after complete relaxation of elastic means 3. The function of limiting spacing thus does not interfere with the progressiveness function or elasticity function.

As is evident from FIGS. 2 and 3, shim 4′ can also have stops limiting how axially close the shims can come, formed by recesses or frustoconical pads 20 created, for example by stamping, in a radially central area of shim 4.

Stops 20 of this kind are known in particular from patent application FR 11/61042, and prevent degradation of elastic means 3 in the engagement phase.

In particular, stops 20 are configured to act before the compression of cords 13 made of elastomer reaches a remanent compressive deformation threshold value beyond which said cords 13 irreversibly exhibit a residual deformation when then return to their idle position.

As an example, the remanent compressive deformation threshold of silicone is on the order of 50%. In order to ensure that the remanent deformation threshold is not reached, it is therefore possible to provide that stops 20 are able to limit the clamping travel to less than 35% of the axial thickness of cords 13 in the idle position when the nominal load of the clutch is reached. Stops 20 preferably come into contact with the opposite shim 4 at a clamping travel that is between 20% and 35% of the axial thickness of cords 13 made of elastomer. This clamping travel limitation furthermore allows the cords made of elastomer to be used in an operating range of particular interest in which deformation as a function of pressure is substantially linear.

Stops 20 obviously have a stiffness that is greater than that of cords 13 made of elastomer. As an example, stops 20 are configured to generate an axial compressive stiffness of friction device 1 greater than 30,000 kN/m, preferably greater than 50,000 kN/m.

Shims 4, 4′ can be equipped, or not, with slots 21 as depicted in FIGS. 2 to 4. Slots 21 of this kind allow the gripping homogeneity of elastic means 3 to be improved.

In a variant that is not depicted, stops 20 are formed by elements applied against the inner surface of at least one shim 4, 4′. These applied elements can be made in particular of steel or elastomer, and can be assembled onto the shim(s) by adhesive bonding or welding.

Other types of stops can also be used, such as annularly shaped stops or those in the shape of annular segments.

Friction device 1 depicted in FIGS. 2 to 4 is produced as follows:

First of all, shims 4, 4′ are obtained by stamping sheet metal. Stops 20 and the recessed 17 and indented area(s) 18 of shim 4 are produced during stamping. Shim 4′ likewise has, at its radially outer periphery and after stamping, at least one tab 15 extending radially outward, preferably at least two diametrically opposite tabs 15. As indicated previously, each tab 15 extends from an indented area 18 of outer periphery 14 of shim 4.

Annular and concentric cords 13 made of elastomer, for example made of silicone, are applied onto that surface of one of shims 4, 4′ which faces toward the other shim.

The two opposite shims 4, 4′ are then kept parallel at a defined axial distance from one another, the assemblage then being brought to a temperature between 150 and 220° C. for a period of between 2 and 15 minutes, for example, in order to polymerize the cords 13 made of elastomer.

Upon completion of polymerization, each tab 15 is folded down so that it extends substantially axially, then hook or rim 16 is produced by bending the free end of tab 15 so that it extends, in the corresponding recessed area 17, oppositely to radially outer periphery 14 of shim 4′, more specifically oppositely to the corresponding indented area 18.

FIGS. 5 and 6 illustrate another embodiment according to the invention in which the stop members that are able to limit the spacing between shims 4, 4′ are formed by first tabs 22, 22′ arched toward the opposite shim 4, 4′, and second tabs 23, 23′ curved toward the opposite shim 4′, 4 and located oppositely to first tabs 22, 22′. Tabs 22, 23 are integral with shim 4, and tabs 22′, 23′ are integral with shim 4′.

Second tabs 23, 23′ have openings 24 in which the free ends of first tabs 22, 22′ engage. The free ends of first tabs 22, 22′ are intended to come into abutment against rims 25 of openings 24 located in the proximity of the free ends of second tabs 23, 23′, in order to limit the axial displacement of one shim with respect to the other. Insertion can be produced either by elastic flexion of tabs 22, 23 in response to an axial pressure applied in one of the assembly operations. Provision can also be made to effect latching by plastic bending of tabs 23 during an assembly operation.

Each shim 4, 4′ can of course have only tabs 22 of the first type or tabs 23 of the second type, the number of tabs 22, 23 being dependent on the axial forces applied and on the dimensioning of said tabs 22, 23.

Any other form of tab or opening can likewise be envisaged in order to provide the function of limiting the axial displacement of one shim with respect to the other.

1. A friction device (1) for a clutch, comprising at least two opposite annular friction linings (2, 2′) each having at least one friction body (9, 9′) attached to a support (4, 4′) and elastic means (3) arranged between the opposite compression or relaxation of the elastic means (3), the friction device (1) further having means for limiting the axial spacing between the supports,
wherein the means for limiting the axial spacing between the supports have at least one stop member (15) extending axially from one support (4) to the other (4′) and disposed on the radially outer (14) or inner periphery of the supports (4, 4′).

2. The friction device (1) according to claim 1, wherein the stop member is formed by a tab (15) that is integral with one (4) of the supports (4, 4′) and is bent over axially toward the other support (4′), the free end of the tab (15) having at least one hook or rim (16) extending radially inward and able to come into abutment against the radially outer (14) or inner periphery of the other support (4′).

3. The friction device (1) according to claim 1, wherein the stop member is formed by a member different from the supports (4, 4′) and is generally in the shape of a U having two radial limbs connected by an axial base, one of the limbs being attached to the radially outer (14) or inner periphery of one of the supports (4, 4′), the other limb being able to come into abutment against the radially outer (14) or inner periphery of the other support.

4. The friction device (1) according to claim 2, wherein the radially outer (14) or inner periphery of the other support (4′) has an area (17) recessed toward the opposite support (4), intended to accommodate the hook or rim (16) of the tab (15) or intended to accommodate the corresponding limb of the stop member.

5. The friction device (1) according to one of claim 1, wherein the respective radially outer (14) and radially inner peripheries of the supports (4, 4′) have areas (18) indented respectively inward and outward, at which the stop members (15) are disposed.

6. The friction device (1) according to one of claim 1, wherein the stop member (15) has a radially extending grip tab (19).

7. The friction device (1) according to claim 1, wherein at least one of the supports (4, 4′) has at least one first tab (22) intended to be engaged into an opening (24) configured in the opposite support, the first tab being designed to come into abutment against an edge (25) of the opening (24) in order to limit the axial displacement of one support with respect to the other.

8. The device according to claim 7, wherein the opening (24) is configured in a second tab (23) extending from the other support (4, 4′).

9. The device according to claim 8, wherein the first tab (22) and/or the second tab (23) extend toward the opposite support.

10. The friction device (1) according to one of claim 1, wherein the elastic means (3) have at least one deformable element (13) made of elastomer.

11. The friction device (1) according to claim 10, wherein the elastic means (3) have concentric annular elements (13) made of elastomer.

12. The friction device (1) according to one of claim 1, wherein it has at least one stop (20) limiting how axially close the supports (4, 4′) can come.

13. The friction device (1) according to one of claim 1, wherein the elastic means (3) are designed, as they relax, to cause the supports (4, 4′) to move apart to a value corresponding to a first spacing, the stop member (15) preventing the supports (4, 4′) from moving apart beyond a second spacing greater than or equal to the first spacing.

14. A method for producing a friction device (1) according to claim 11, wherein it comprises the steps of:
placing annular cords (13) made of elastomer onto one surface of one of the supports (4, 4′),
placing the other support onto the cords (13) made of elastomer, the two opposite supports (4, 4′) being kept parallel at a defined axial distance from one another,
at least partly polymerizing the cords (13) made of elastomer,
positioning or engaging the stop member on the radially outer (14) or inner periphery of the supports (4, 4′) before or after the placement and polymerization of said cords (13).

15. The friction device (1) according to claim 3, wherein the radially outer (14) or inner periphery of the other support (4′) has an area (17) recessed toward the opposite support (4), intended to accommodate the hook or rim (16) of the tab (15) or intended to accommodate the corresponding limb of the stop member.

16. The friction device (1) according to one of claim 2, wherein the respective radially outer (14) and radially inner peripheries of the supports (4, 4′) have areas (18) indented respectively inward and outward, at which the stop members (15) are disposed.

17. The friction device (1) according to one of claim 3, wherein the respective radially outer (14) and radially inner peripheries of the supports (4, 4′) have areas (18) indented respectively inward and outward, at which the stop members (15) are disposed.

18. The friction device (1) according to claim 4, wherein the respective radially outer (14) and radially inner peripheries of the supports (4, 4′) have areas (18) indented respectively inward and outward, at which the stop members (15) are disposed.

19. The friction device (1) according to claim 2, wherein the stop member (15) has a radially extending grip tab (19).

20. The friction device (1) according to claim 3, wherein the stop member (15) has a radially extending grip tab (19).

21. The friction device (1) according to claim 4, wherein the stop member (15) has a radially extending grip tab (19).

22. The friction device (1) according to claim 5, wherein the stop member (15) has a radially extending grip tab (19).
